(19) United States
(12) Patent Application Publication
(10) Pub. No.: US 2006/0268211 A1
(43) Pub. Date: Nov. 30, 2006

(54) In plane switching liquid crystal display with anti-crosstalk common electrode branches

(75) Inventor: Hung-Yu Chen, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/442,779

(22) Filed: May 30, 2006

(30) Foreign Application Priority Data
May 27, 2005 (TW) 94117389

(51) Int. Cl. G02F 1/1343

(52) U.S. Cl. 349/141

(57) ABSTRACT

An in plane switching liquid crystal display includes a first substrate (110) and a second substrate (120) opposite to each other, a liquid crystal layer (130) sandwiched between the first and second substrates, a plurality of gate lines (140) and data lines (150) formed on the second substrate, and a first pixel region 100 defined by two adjacent of the data lines and two adjacent of the gate lines. The first pixel region includes a pixel electrode (182) with a pixel branch (1821) parallel to the data lines and a common electrode (181) formed at the second substrate. The common electrode has at least one common branch (1811, 1816 and 1812) adjacent and substantially parallel to a respective one of the data lines and including at least one opening overlying the respective data line. The IPS LCD can reduce crosstalk and avoid having increased circuit loading and increased power consumption.

### FIELD OF THE INVENTION

The present invention relates to liquid crystal displays (LCDs), and particularly relates an in plane switching (IPS) mode LCD having common electrode branches configured for reducing crosstalk between pixel electrodes and data lines.

### BACKGROUND

An active matrix LCD generally includes a plurality of pixel regions defined by a plurality of gate lines and a plurality of data lines that cross each other. A plurality of thin film transistors (TFTs) are respectively arranged at intersections of the gate lines and the data lines. Each pixel region includes a pixel electrode, which is controlled by a corresponding TFT.

Rapid progress in the performance of active matrix LCDs has opened up a wide range of the commercial and consumer applications, such as in flat television (TV) systems, and high-information content monitors for portable computers. A common type of technology used in these displays is twisted nematic (TN) display mode. However, conventional TN display mode has intrinsic properties including narrow viewing angle characteristics and slow response times. Most particularly, TN display mode has slow response times for gray scale operation.

In order to overcome these limitations, various techniques for use in active matrix LCDs have been developed. For example, IPS (In Plane Switching) mode involves electrodes formed on a same one of two substrates of an LCD. The electrodes control orientations of liquid crystal molecules in a liquid crystal layer of the LCD. In the IPS mode, the electrodes on the same substrate can produce an electrical field parallel to the substrate. Thus, the liquid crystal molecules can be aligned in a plane parallel to the substrate.

Referring to FIG. 8, this shows one pixel region of a first kind of typical IPS LCD. The pixel region 10 is defined by two adjacent gate lines 11 and two adjacent data lines 12 crossing each other. The pixel region 10 includes a common electrode 13, a pixel electrode 14, and a thin film transistor (TFT) 15. The TFT 15 includes a gate electrode 16 electrically connecting with one of the gate lines 11, a source electrode 17 electrically connecting with one of the data lines 12, and a drain electrode 18 electrically connecting with the pixel electrode 14. The common electrode 13 includes a common base line 13a parallel to the gate lines 11, and a plurality of common branches 13b, 13c, and 13d extending from the common base line 13a and being parallel to the data lines 12. The pixel electrode 14 includes a pixel base line 14a parallel to the gate lines 11, and a plurality of pixel branches 14b, 14c extending from the pixel base line 14a and being parallel to the data lines 12. The pixel branches 14b, 14c and the common branches 13b, 13c, and 13d are parallel to each other, and are alternately arranged.

Because the pixel branches 14b, 14c are parallel to the data lines 12, the pixel branches 14b, 14c and the data lines 12 can form unwanted capacitors. When the pixel region 10 is in an on state, different voltage signals are applied to the pixel branches 14b, 14c and the data lines 12 respectively. Therefore a parasitic capacitance is liable to formed between the pixel branches 14b, 14c and the data lines 12, and a parasitic electric field spanning from the data lines 12 to the pixel branches 14b, 14c is liable to be produced. Because of the parasitic electric field, the voltage signals applied to the data lines 12 and the voltage signals applied to the pixel branches 14b, 14c may interfere with each other. That is, crosstalk can be generated between the pixel branches 14b, 14c and the data lines 12. Accordingly, the display performance of the IPS LCD can be adversely affected.

In order to overcome the above-described difficulties of the IPS LCD with the pixel regions 10, another kind of IPS LCD was developed. Referring to FIG. 9, this shows one pixel region 20 of a second kind of typical IPS LCD. In the pixel region 20, common branches 23b, 23c of a common electrode 23 are arranged on data lines 22 and cover portions of the data lines 22. When the pixel region 20 is in an on state, a voltage applied to the common electrode 23 is substantially constant. Thus, the common branches 23b, 23c and the data lines 22 can form an electric field to suppress a parasitic electric field generated by the data lines 22. That is, the common electrode 23 provides a “shielding effect”. Therefore, a parasitic capacitance between pixel branches 24b, 24c of a pixel electrode 24 and the data lines 22 can be reduced. Crosstalk between the pixel branches 24b, 24c and the data lines 22 can be reduced, and the display performance of the IPS LCD may be only minimally impaired by crosstalk.

However, because the common branches 23b, 23c are arranged on the data lines 22 and cover portions of the data lines 22, short circuits are liable to occur between the common branches 23b, 23c and the data lines 22. Furthermore, the common branches 23b, 23c covering portions of the data lines 22 may increase a circuit loading of the data lines 22. Accordingly, the IPS LCD may consume an excessive amount of electrical energy.

What is needed, therefore, is an IPS LCD which can reduce crosstalk and facilitate good display performance while avoiding increased circuit loading and increased power consumption.

### SUMMARY

A first in plane switching liquid crystal display includes a first substrate and a second substrate opposite to each other, a liquid crystal layer sandwiched between the first and second substrates, a plurality of gate lines and a plurality of data lines formed on the second substrate, and a first pixel region defined by two adjacent of the data lines and two adjacent of the gate lines. The first pixel region includes a pixel electrode and a common electrode formed at the second substrate to generate a substantially planar electric field. The pixel electrode includes a pixel branch parallel to the data lines. The common electrode includes a plurality of a common electrode. At least one of the common branches is adjacent and substantially parallel to a respective one of the data lines, and includes at least one opening corresponding overlying the respective data line.

A second in plane switching liquid crystal display includes a substrate, a plurality of data lines and gate lines formed at the and crossing each other, thereby defining a plurality of pixel regions. Each of the pixel regions includes a pixel electrode formed at the substrate and including a pixel branch parallel to the data lines, and a common electrode formed at the substrate and including a plurality of common branches parallel to the data lines. Two adjacent common branches respectively of two adjacent pixel regions are adjacent opposite sides of one data line that the adjacent pixel regions having in common, and a distance between the two adjacent common branches is the same as or greater than a corresponding width of the common data line. At least one bridge portion is provided over the common data line, the at least one bridge portion electrically interconnecting the two adjacent common branches.

In the first in-plane switching liquid crystal display, the common electrode has at least one of the common branches is adjacent and substantially parallel to a respective one of the data lines, and includes at least one opening corresponding overlying the respective data line. Therefore, the common branch and the corresponding data line can form a shielding electric field to suppress any parasitic electric filed generated by the data lines. Accordingly, unlike in the above-described conventional IPS LCD having the conventional pixel regions 10, crosstalk between the pixel branch and the data lines can be reduced, and the display performance of the first IPS LCD may be only minimally impaired by crosstalk. Moreover, at most, because of the common branch including at least one opening overlying the respective data line, the solid portion of the common branch overlying said one of the data lines can be reduced. Accordingly, unlike in the above-described conventional IPS LCD having the conventional pixel regions 20, any circuit loading applied to the data lines by the common branch can be reduced. Thus the first in-plane switching liquid crystal display can avoid having increased circuit loading and increased power consumption.

In the second in-plane switching liquid crystal display, two adjacent common branches respectively of two adjacent pixel regions are adjacent the opposite sides of one data line that the adjacent pixel regions having in common, and the distance between the two adjacent common branches is the same as or greater than a corresponding width of the common data line. Further, at least one bridge portion electrically interconnecting the two adjacent common branches. Therefore, the common branch and the corresponding data line can generate a shielding electric field to suppress any parasitic electric filed generated by the data lines. Accordingly, unlike in the above-described conventional IPS LCD having the pixel regions 10, crosstalk between the pixel branch and the data lines can be reduced, and the display performance of the second IPS LCD may be only minimally impaired by crosstalk. Moreover, at most, any solid portion or portions of the two adjacent common branches overlying said one of the data lines is merely the bridge portion. Accordingly, unlike in the above-described conventional IPS LCD having the conventional pixel regions 20, any circuit loading applied to the data lines by the common branch can be reduced. Thus the second in-plane switching liquid crystal display can avoid having increased circuit loading and increased power consumption.

Other advantages and novel features will become more apparent from the following detailed description when taken in conjunction with the accompanying drawings, in which:

### BRIEF DESCRIPTION OF THE DRAWINGS

FIG. 1 is a schematic, side cross-sectional view of part of an IPS LCD according to a first preferred embodiment of the present invention;

FIG. 2 is a schematic, top plan view of certain parts of a pixel region of the IPS LCD shown in FIG. 1;

FIG. 3 is essentially a schematic, side cross-sectional view corresponding to a line III-III of FIG. 2;

FIG. 4 is a schematic, top plan view of certain parts of a pixel region of an IPS LCD according to a second preferred embodiment of the present invention;

FIG. 5 is a schematic, isometric view of certain parts of a pixel region of an IPS LCD according to a third preferred embodiment of the present invention;

FIG. 6 is a schematic, top plan view of certain parts of a pixel region of an IPS LCD according to a fourth preferred embodiment of the present invention;

FIG. 7 is a schematic, top plan view of certain parts of a pixel region of an IPS LCD according to a fifth preferred embodiment of the present invention;

FIG. 8 is a schematic, top plan view of certain parts of a pixel region of a first kind of conventional IPS LCD; and

FIG. 9 is a schematic, top plan view of certain parts of a pixel region of a second kind of conventional IPS LCD.

### DETAILED DESCRIPTION OF PREFERRED EMBODIMENTS

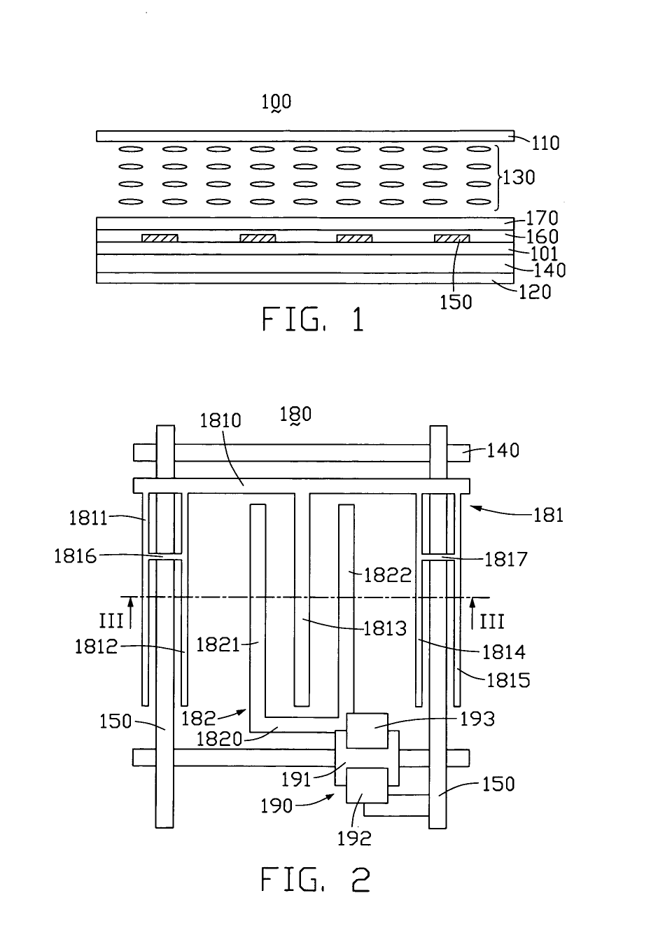

Referring to FIG. 1, this shows part of an IPS LCD according to a first preferred embodiment of the present invention. The IPS LCD 100 includes a first substrate 110 and a second substrate 120 opposite to each other, and a liquid crystal layer 130 having a plurality of liquid crystal molecules sandwiched between the first and second substrates 110, 120. A plurality of parallel gate lines 140 and parallel data lines 150 are formed on the second substrate 120. The gate lines 140 and the data lines 150 cross each other, and any two adjacent gate lines 140 together with any two adjacent data lines 150 define a pixel region 180 (see FIG. 2). Thus the IPS LCD 100 has a plurality of pixel regions 180. An insulation layer 101 is provided to insulate the gate lines 140 and the data lines 150 from each other. A passivation layer 160 is arranged on the data lines 150 and the insulation layer 101. An alignment layer 170 is provided on the passivation layer 160, and is adjacent to the liquid crystal layer 130.

Referring to FIG. 2, this shows an exemplary pixel region 180 of the IPS LCD 100. The pixel region 180 includes a common electrode 181, a pixel electrode 182, and a TFT 190. The TFT 190 includes a gate electrode 191 connecting with one of the gate lines 140, a source electrode 192 connecting with one of the data lines 150, and a drain electrode 193 connecting with the pixel electrode 182. The common electrode 181 is arranged above the data lines 150. The common electrode 181 includes a common base line 1810 parallel to the gate lines 140, a plurality of common branches 1811, 1812, 1813, 1814 and 1815 extending from the common base line 1810 and being parallel to the data lines 150, and a plurality of bridge portions 1816, 1817. The common branches 1811, 1812, 1813, 1814 and 1815 are perpendicular to the common base line 1810. The pixel electrode 182 includes a pixel base line 1820, and a plurality of pixel branches 1821 and 1822 extending from the pixel base line 1820 and being parallel to the data lines 150. The pixel branches 1821 and 1822 are perpendicular to the pixel base line 1820. The common branches 1811 and 1812 are arranged generally adjacent to opposite sides of one of the data lines 150 respectively. A distance between the common branches 1811 and 1812 can be equal to or greater than a width of the data line 150. The bridge portion 1816 electrically interconnects the common branches 1811 and 1812. That is, the bridge portion 1816 is essentially a beam that crosses over the data line 150 between the common branches 1811, 1812. Similarly, the common branches 1814 and 1815 are arranged generally adjacent to opposite sides of the other data line 150 respectively. A distance between the common branches 1814 and 1815 can be equal to or greater than a width of the data line 150. The bridge portion 1817 electrically interconnects the common branches 1814 and 1815. That is, the bridge portion 1817 is essentially a beam that crosses over the data line 150 between the common branches 1814, 1815. A length of the bridge portion 1816 corresponds to the distance between the common branches 1811 and 1812, and a length of the bridge portion 1817 corresponds to the distance between the common branches 1814 and 1815.

In addition, the bridge portion 1816 can be considered as a portion of the common branch 1811, a portion of the common branch 1812, or a portion commonly shared by both the common branches 1811, 1812. Further, the two adjacent common branches 1811, 1812 and the bridge portion 1816 can be considered as a single body. Such single body can be considered as defining at least one opening therein, the at least one opening overlying said one of the data lines 150. Similarly, the bridge portion 1817 can be considered as a portion of the common branch 1814, a portion of the common branch 1815, or a portion commonly shared by both the common branches 1814, 1815. Further, the two adjacent common branches 1814, 1815 and the bridge portion 1817 can be considered as a single body. Such single body can be considered as defining at least one opening therein, the at least one opening overlying said other data line 150.

In the illustrated embodiment, the common branches 1811, 1812, 1813, 1814, 1815, and the pixel branches 1821, 1822 are straight. In addition, the common branches 1811, 1812 can be considered as common branches of a pixel region 180 (essentially not shown) that is adjacent to the pixel region 180 illustrated. Similarly, the common branches 1814, 1815 can be considered as common branches of another pixel region 180 (essentially not shown) that is adjacent to the pixel region 180 illustrated. Further, common base lines 1810 of any two or more laterally adjacent pixel regions 180 can substantially constitute a single straight continuous common base line.

Referring to FIG. 3, this is essentially a schematic, side cross-sectional view corresponding to a line III-III of FIG. 2. The common branches 1811, 1812, 1813, 1814, 1815, and the pixel branches 1821, 1822 are alternately arranged along the passivation layer 160. The common branches 1811 and 1812 are arranged above said one of the data lines 150, and are generally adjacent opposite sides of the data line 150 respectively. The common branches 1814 and 1815 are arranged above said other data line 150, and are generally adjacent opposite sides of the data line 150 respectively. The alignment layer 170 is arranged on the passivation layer 160, the common branches 1811, 1812, 1813, 1814, 1815, and the pixel branches 1821, 1822. The common branches 1811, 1812, 1813, 1814, 1815 and the pixel branches 1821, 1822 are made of transparent electrically conductive material, such as indium tin oxide (ITO), indium zinc oxide (IZO), and so on.

As described above, the common branches 1811, 1812 are generally adjacent the opposite sides of said one of the data lines 150, and the distance between the common branches 1811, 1812 is equal to or greater than the width of the data line 150. Further, the bridge portion 1816 over the data line 150 electrically interconnects the common branches 1811, 1812. Therefore, the common branches 1811, 1812 and the corresponding data line 150 can generate a shielding electric field to suppress any parasitic electric field generated by the data lines 150. Similarly, the common branches 1814, 1815 and the corresponding data line 150 can generate a shielding electric field to suppress any parasitic electric field generated by the data lines 150. Accordingly, unlike in the above-described conventional IPS LCD having the pixel regions 10, crosstalk between the pixel branches 1821, 1822 and the data lines 150 can be reduced, and the display performance of the IPS LCD 100 may be only minimally impaired by crosstalk. Moreover, at most, any solid portion or portions of the common branches 1811 and 1812 overlying said one of the data lines 150 is merely the bridge portion 1816. Similarly, at most, any solid portion or portions of the common branches 1814 and 1815 overlying said other data line 150 is merely the bridge portion 1817. Accordingly, unlike in the above-described conventional IPS LCD having the pixel regions 20, any circuit loading applied to the data lines 150 by the common branches 1811, 1812, 1814, 1815 can be reduced. Thus the IPS LCD 100 can avoid having increased circuit loading and increased power consumption.

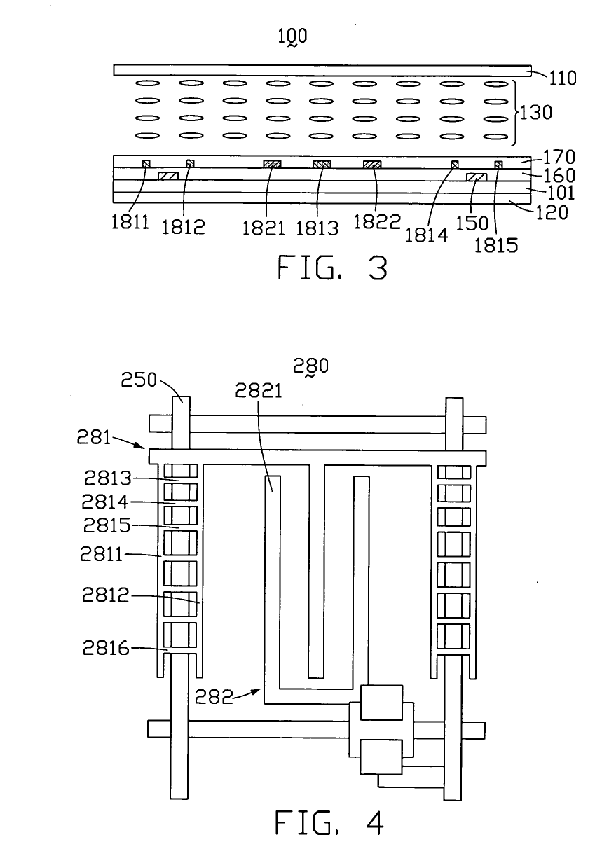

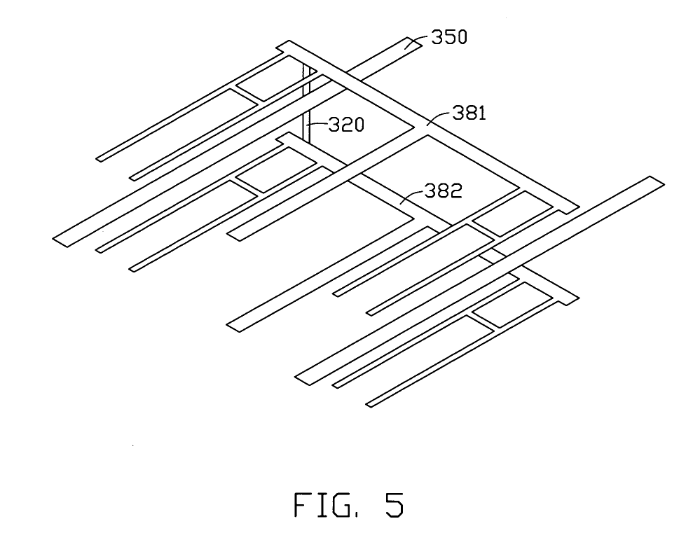

Referring to FIG. 4, this shows a pixel region 280 of an IPS LCD according to a second preferred embodiment of the present invention. The pixel region 280 has a structure similar to that of the pixel region 180 of the IPS LCD 100. The pixel region 280 includes two data lines 250 (only one data line labeled), a common electrode 281 with a plurality of common branches 2811, 2812 (only two common branches labeled), and a pixel electrode 282 with a plurality of pixel branches 2821 (only one pixel branch labeled). Hereinafter, only the left side of the illustrated pixel region 280 will be described, for the purposes of explaining key features that are applicable to the whole pixel region 280. The common branches 2811, 2812 are generally adjacent to opposite sides of the data line 250 respectively. The common electrode 281 further includes a plurality of separate bridge portions 2813, 2814, 2815, . . . 2816 respectively interconnecting the common branches 2811, 2812. The bridge portions 2813, 2814, 2815, . . . 2816 are essentially beams that cross over the data line 250 between the common branches 2811, 2812. In addition, the common branches 2811, 2812 and the bridge portions 2813, 2814, 2815, . . . 2816 can be considered as a single body. Such single body can be considered as defining a plurality of openings therein, the openings overlying the data line 250.

For reasons similar to those described above in relation to the pixel region 180, unlike in the above-described conventional IPS LCD having the pixel regions 10, crosstalk between the pixel branches 2821 and the data lines 250 can be reduced, and the display performance of the IPS LCD may be only minimally impaired by crosstalk. Further, at most, any solid portions of the common branches 2811 and 2812 overlying the data line 250 are merely the bridge portions 2813, 2814, 2815, . . . 2816. Accordingly, unlike in the conventional IPS LCD having the pixel regions 20, any circuit loading applied to the data line 250 by the common branches 2811, 2812 can be reduced. Thus the IPS LCD with the pixel regions 280 can avoid having increased circuit loading and increased power consumption. Moreover, in various embodiments, the number and sizing of the bridge portions 2813, 2814, 2815, . . . 2816 can be configured according to a loading capability of the data lines 250.

Referring to FIG. 5, this shows part of a pixel region 380 of an IPS LCD according to a third preferred embodiment of the present invention. The pixel region 380 includes a first common electrode 381 provided above two data lines 350, and a second common electrode 382 provided under the same data lines 350. Each of the first common electrode 381 and the second common electrode 382 can have a structure similar to that of the common electrode 181 of the pixel region 180 or the common electrode 281 of the pixel region 280. That is, the first common electrode 381 and the second common electrode 382 can have a same structure or different structures. The first common electrode 381 and the second common electrode 382 are electrically interconnected by a conductive via 320, which may extend through a contact hole (not shown). The first common electrode 381 and the second common electrode 382 can be made of transparent electrically conductive material, such as indium tin oxide (ITO), indium zinc oxide (IZO), and so on.

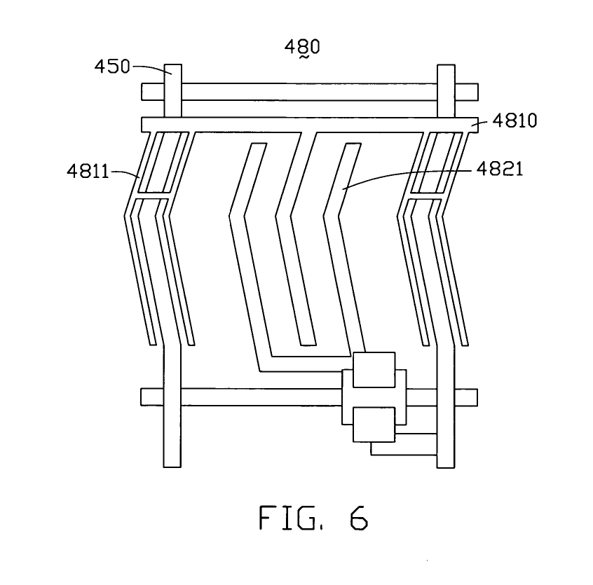

Referring to FIG. 6, this shows a pixel region 480 of an IPS LCD according to a fourth preferred embodiment of the present invention. The pixel region 480 has a structure similar to that of the pixel region 180 of the IPS LCD 100. However, the pixel region 480 includes two data lines 450, a plurality of common branches 4811, and a plurality of pixel branches 4821. Each data line 450 is bent, and includes a plurality of straight portions. Correspondingly, the common branches 4811 and the pixel branches 4821 are also bent. Thus the common branches 4811 obliquely extend from a common base line 4810.

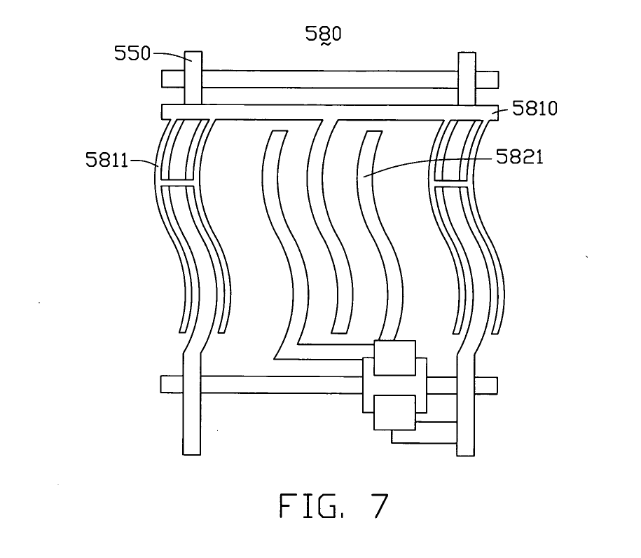

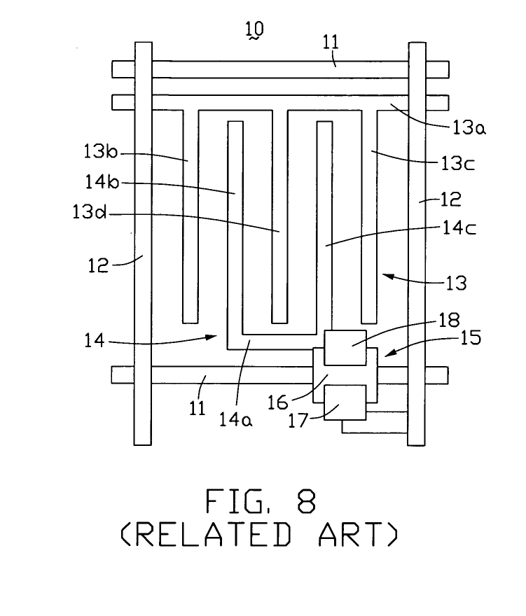

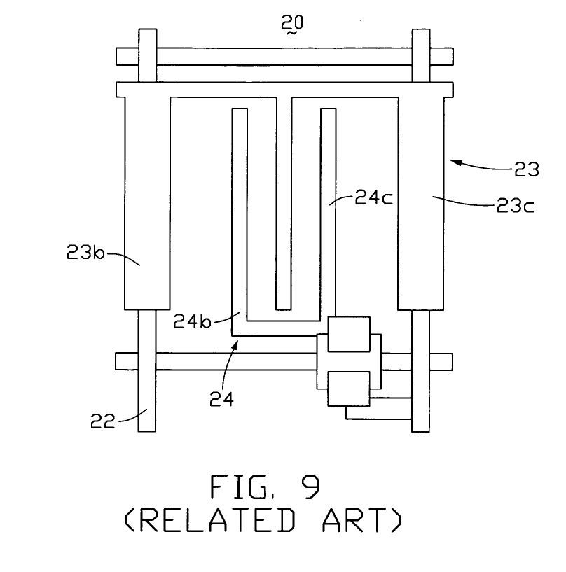

Referring to FIG. 7, this shows a pixel region 580 of an IPS LCD according to a fifth preferred embodiment of the present invention. The pixel region 580 has a structure similar to that of the pixel region 180 of the IPS LCD 100. However, the pixel region 580 includes two data lines 550, a plurality of common branches 5811, and a plurality of pixel branches 5821. Each data line 550 is wavy. Correspondingly, the common branches 5811 and the pixel branches 5821 are also wavy. Thus the common branches 5811 obliquely extend from a common base line 5810.

It is to be further understood that even though numerous characteristics and advantages of various embodiments have been set forth in the foregoing description, together with details of the structures and functions of the embodiments, the disclosure is illustrative only, and changes may be made in detail to the full extent indicated by the broad general meaning of the terms in which the appended claims are expressed.

What is claimed is:

1. An in plane switching liquid crystal display, comprising:
a first substrate and a second substrate opposite to each other;
a liquid crystal layer sandwiched between the first and second substrates;
a plurality of gate lines and a plurality of data lines formed on the second substrate; and
a first pixel region defined by two adjacent of the data lines and two adjacent of the gate lines, the first pixel region comprising a pixel electrode and a common electrode formed at the second substrate to generate a substantially planar electric field, wherein the pixel electrode comprises a pixel branch parallel to the data lines, and the common electrode comprises a plurality of common branches parallel to the data lines;
wherein at least one of the common branches is adjacent and substantially parallel to a respective one of the data lines, and comprises at least one opening overlying the respective data line.

2. The in plane switching liquid crystal display as recited in claim 1, wherein the common electrode further comprises a common base line parallel to the gate lines.

3. The in plane switching liquid crystal display as recited in claim 2, further comprising a second pixel region having substantially the same configuration as that of the first pixel region and adjoining the first pixel region including by way of having one data line in common, wherein the common base lines of the first and second pixel regions substantially constitute a unitary continuous common base line.

4. The in plane switching liquid crystal display as recited in claim 2, wherein the common branches perpendicularly adjoin the common base line, or obliquely adjoin the common base line.

5. The in plane switching liquid crystal display as recited in claim 1, wherein the common branches are straight, bent, or wavy.

6. The in plane switching liquid crystal display as recited in claim 1, wherein the pixel electrode further comprises a pixel base line parallel to the gate lines.

7. The in plane switching liquid crystal display as recited in claim 1, wherein the common branches and the pixel branch are made of transparent material.

8. The in plane switching liquid crystal display as recited in claim 1, wherein the at least one common branch further comprises a solid portion overlying to the respective data line.

9. The in plane switching liquid crystal display as recited in claim 1, wherein a width of the opening is equal to or greater than a corresponding transverse width of the respective data line.

10. An in plane switching liquid crystal display, comprising:
a substrate; and
a plurality of data lines and gate lines formed at the substrate and crossing each other, thereby defining a plurality of pixel regions;
wherein each of the pixel regions comprises a pixel electrode formed at the substrate and comprising a pixel branch parallel to the data lines, and a common electrode formed at the substrate and comprising a plurality of common branches parallel to the data lines;
two adjacent common branches respectively of two adjacent pixel regions are adjacent opposite sides of one data line that the adjacent pixel regions having in common, and a distance between the two adjacent common branches is the same as or greater than a corresponding width of the common data line; and
at least one bridge portion is provided over the common data line, the at least one bridge portion electrically interconnecting the two adjacent common branches.

11. The in plane switching liquid crystal display as recited in claim 10, wherein the common electrode of each pixel region further comprises a common base line parallel to the gate lines.

12. The in plane switching liquid crystal display as recited in claim 10, wherein the at least one bridge portion is beam-shaped.

13. The in plane switching liquid crystal display as recited in claim 12, wherein a length of the beam corresponds to the distance between the two adjacent common branches.

14. The in plane switching liquid crystal display as recited in claim 11, wherein the common branches perpendicularly adjoin the common base line, or obliquely adjoin the common base line.

15. The in plane switching liquid crystal display as recited in claim 10, wherein the common branches are straight, bent, or wavy.

16. The in plane switching liquid crystal display as recited in claim 10, wherein the pixel electrode of each pixel region further comprises a pixel base line parallel to the gate lines.

17. The in plane switching liquid crystal display as recited in claim 10, wherein the common branches and the pixel branch are made of transparent material.

18. The in plane switching liquid crystal display as recited in claim 10, wherein the distance between the two adjacent common branches is equal to or greater than a width of the corresponding data line.

19. An in plane switching liquid crystal display, comprising:
a substrate; and
a plurality of data lines and gate lines formed at the substrate and crossing each other, thereby defining a plurality of pixel regions;
wherein each of the pixel regions comprises a pixel electrode formed at the substrate and comprising a pixel branch parallel to the data lines, and a common electrode formed at the substrate and comprising a plurality of common branches parallel to the data lines;
two adjacent common branches respectively of two adjacent pixel regions are adjacent opposite sides of one data line that the adjacent pixel regions having in common, and a width of each of said common branches being smaller than that of the common data line; and
at least one bridge portion is provided over the common data line, the at least one bridge portion electrically interconnecting the two adjacent common branches.
